(19) United States
(12) Patent Application Publication
(10) Pub. No.: US 2017/0097091 A1
(43) Pub. Date: Apr. 6, 2017

(54) INVERTED PISTON CONFIGURATIONS FOR INTERNAL COMBUSTION ENGINES

(71) Applicant: Pinnacle Engines, Inc., San Carlos, CA (US)

(72) Inventors: James M. Cleeves, Redwood City, CA (US); Simon David Jackson, Redwood City, CA (US); Joshua Raimond, Redwood City, CA (US)

(21) Appl. No.: 15/286,442

(22) Filed: Oct. 5, 2016

Related U.S. Application Data
(60) Provisional application No. 62/237,440, filed on Oct. 5, 2015.

(51) Int. Cl. F16J 9/20; F02F 3/28; F02F 3/00

(52) U.S. Cl. CPC F16J 9/20; F02F 3/0015; F02F 3/28

(57) ABSTRACT

An inverted combustion engine is described herein that can reduce or eliminate the amount of oil that leaks into a combustion volume of a combustion chamber. In some implementations, at least one piston of the combustion engine includes a crown that faces the combustion volume and a cavity on an opposing side of the crown that is configured to collect and contain oil that has entered the combustion chamber.

### CROSS-REFERENCE TO RELATED APPLICATION

The current application claims priority under 35 U.S.C. §119(e) to U.S. Provisional patent application Ser. No. 62/237,440, filed on Oct. 5, 2015 and entitled “INVERTED PISTON CONFIGURATIONS FOR INTERNAL COMBUSTION ENGINES,” which is incorporated by reference herein in its entirety.

### TECHNICAL FIELD

The subject matter described herein relates generally to internal combustion engines, and in some particular examples, to vertically oriented opposed piston engines and/or to inverted engines.

### BACKGROUND

There are numerous types of internal combustion engines in use today. Reciprocating piston internal combustion engines are very common in both two- and four-stroke configurations. Such engines can include one or more pistons reciprocating in individual cylinders arranged in different configurations. The pistons are typically coupled to a crankshaft, and draw a fuel/air mixture into the cylinder during a downward stroke and compress the fuel/air mixture during an upward stroke. The fuel/air mixture can be ignited near the top of the piston stroke by a spark plug or other means, and the resulting combustion and expansion can drive the piston downwardly, thereby transferring chemical energy of the fuel into mechanical work by the crankshaft.

As is well known, conventional reciprocating piston internal combustion engines have a number of limitations—not the least of which is that much of the chemical energy of the fuel is wasted in the forms of heat and friction. As a result, only about 25% of the fuel's energy in a typical car or motorcycle engine is actually converted into shaft work for moving the vehicle, generating electric power for accessories, etc.

Opposed-piston internal combustion engines can overcome some of the limitations of conventional reciprocating engines. Such engines typically include pairs of opposing pistons that reciprocate toward and away from each other in a common cylinder to decrease and increase the volume of the combustion chamber formed therebetween. Each piston of a given pair is coupled to a separate crankshaft, with the crankshafts typically coupled together by gears or other systems to provide a common driveline and to control engine timing. Each pair of pistons defines a common combustion volume or cylinder, and engines can be composed of many such cylinders, with a crankshaft connected to more that one piston, depending on engine configuration. Such engines are disclosed in, for example, U.S. patent application Ser. No. 12/624,276, which is incorporated herein in its entirety by reference.

In contrast to conventional reciprocating engines which typically use reciprocating poppet valves to transfer fresh fuel and/or air into the combustion chamber and exhaust combustion products from the combustion chamber, some engines, including some opposed-piston engines, utilize sleeve valves for this purpose. The sleeve valve typically forms all or a portion of the cylinder wall. In some embodiments, the sleeve valve reciprocates back and forth along its axis (e.g., an axis that is parallel to that along which a piston reciprocates in the cylinder) to open and close intake and exhaust ports at appropriate times to introduce air or fuel/air mixture into the combustion chamber and/or to exhaust combustion products from the chamber. In other embodiments, the sleeve valve can rotate about its axis to open and close the intake and exhaust ports, or more via a same combination of rotational and reciprocal motion about/along its axis.

Various fluids can be used with combustion engines to either optimize or enable performance of the combustion engine. For example, oil can provide lubrication to parts of the combustion engine thereby allowing the engine to run efficiently and reduce wear oil can also be used as a coolant fluid. However, when oil leaks into the combustion chamber, the oil can be burned resulting in unacceptable oil consumption as well as elevated generation of smoke and pollutants.

### SUMMARY

Aspects of the current subject matter can include vertically oriented opposed piston engines and/or inverted engines having one or more features for preventing fluids, such as oil, from leaking into the combustion chamber. In one aspect, an internal combustion engine includes a combustion chamber having a combustion volume configured to allow combustion to occur. In addition, the internal combustion chamber can include a piston that reciprocates within a cylinder that at least partially encircles the piston. The piston includes a crown directed toward the combustion volume. The piston can reciprocate within the cylinder such that a position of the crown is lower (e.g. at a lower elevation) when the piston is at a top dead center (TDC) position than when the piston is at a bottom dead center (BDC) position. The piston can include a cavity positioned opposite the crown of the piston, and the cavity can have a volume configured to capture fluid introduced into the combustion chamber above the crown of the piston. Additionally, the internal combustion chamber can include a flow limiter positioned outside of the combustion chamber and configured to limit an amount of fluid introduced into the cylinder above the crown of the piston.

In some variations one or more of the following features can optionally be included in any feasible combination. The flow limiter can include a check valve positioned along a fluid pathway that is in fluid communication with at least one of the cylinder and a crankcase of the internal combustion engine. The check valve can be positioned adjacent at least one of a squirt nozzle configured to cool the piston and a splash shield. The flow limiter can include a splash shield positioned adjacent at least one of the cylinder and a sleeve valve of the internal combustion chamber. The internal combustion engine can further include a seal ring positioned along a perimeter of the piston that directs fluid introduced into the cylinder above the crown into the cavity. The seal ring can be made out of a polymer. The seal ring can include one or more grooves that align with one or more openings along the piston for providing a flow pathway into the cavity. The seal ring can include a shape that allows fluid between the seal ring and the piston when the piston reciprocates thereby providing lubrication between the piston and cylinder. The piston can include one or more drainback apertures along a piston wall that allow fluid to flow from outside the piston wall into the cavity. The drainback apertures can extend at an angle that encourages oil to flow from outside the piston wall into the cavity. The volume of the cavity can include a range of 5 cubic centimeters to 15 cubic centimeters and the fluid can be oil.

In another interrelated aspect of the current subject matter, a method includes limiting an amount of fluid allowed to flow into a cavity of a piston that reciprocates within a cylinder that at least partially encircles the piston. The piston can include a crown directed toward a combustion volume that is at least partially bounded by a wall of the cylinder and the crown. The piston can reciprocate within the cylinder such that the crown is positioned lower when the piston is at a top dead center (TDC) position than when the piston is at a bottom dead center (BDC) position. The cavity of the piston can be positioned opposite the crown of the piston and include a cavity volume configured to capture fluid introduced into the cylinder above the crown of the piston.

In some variations of the method, the limiting can include one or more flow limiters restricting the flow of fluid into the cylinder above the crown of the piston. The method can further include directing the fluid introduced into the combustion chamber above the crown of the piston into the cavity of the piston. The method can further include containing the fluid in the cavity of piston. The volume of fluid can include a range of 5 cubic centimeters to 15 cubic centimeters and the fluid can be oil.

The details of one or more variations of the subject matter described herein are set forth in the accompanying drawings and the description below. Other features and advantages of the subject matter described herein will be apparent from the description and drawings, and from the claims.

### DESCRIPTION OF DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1 illustrates components of an internal combustion engine including vertically aligned opposed pistons;

FIG. 2 illustrates the vertically aligned opposed pistons of the internal combustion engine of FIG. 1 including an upper piston and a lower piston;

FIG. 3 illustrates a cutaway diagram of part of the internal combustion engine including an implementation of an oil control ring for directing oil into a cavity of the upper piston;

FIGS. 4A-4B illustrate additional close-up views of the oil control ring and the upper piston;

FIG. 5 illustrates an embodiment of the oil control ring including grooves that can assist with directing oil into the piston cavity;

FIG. 6A illustrates a perspective view of a molded seal coupled to a piston;

FIG. 6B illustrates a section view of the molded seal coupled to the piston of FIG. 6A;

FIG. 6C illustrates a close up partial view of the section view of FIG. 6B;

FIG. 7A illustrates a perspective view of an embodiment of a molded seal;

FIG. 7B illustrates a perspective view of an embodiment of a molded seal;

FIG. 7C illustrates a cast for forming the molded seal, such as the molded seal of FIG. 7A or 7B;

FIG. 8 illustrates another implementation of a flow limiting seal;

FIG. 9 shows a curvature included on a piston surface leading into a first vent;

FIG. 10 illustrates an embodiment of a piston end cap for closing off a leak path;

FIG. 11A illustrates another embodiment of a piston end cap for closing off a leak path;

FIG. 11B illustrates a diagram showing the inside of the piston of FIG. 11A;

FIG. 12 illustrates an embodiment of a sealing surface of an oil seal coupled to a piston;

FIG. 13 illustrates another embodiment of a sealing configuration between an oil seal and a piston;

FIG. 14 illustrates an implementation of an oil ring having a recess cut;

FIG. 15 illustrates an implementation of an oil ring having a tapered end;

FIG. 16 illustrates an implementation of an oil ring having a tent feature;

FIG. 17 illustrates an implementation of opposed pistons with a check valve and solenoid controlled crankcase vent;

FIG. 18 illustrates a sleeve valve surrounding a top piston and is raised compared to other features in order to prevent oil from draining into the sleeve valve;

FIG. 19A illustrates a perspective view of a shield attached to a sleeve valve;

FIG. 19B illustrates a cross-section view of the shield attached to the sleeve valve of FIG. 19A;

FIG. 19C illustrates a side view of the shield attached to the sleeve valve of FIG. 19A; and

FIG. 20 shows a process flow chart illustrating features of a method consistent with one or more implementations of the current subject matter.

When practical, similar reference numbers denote similar structures, features, or elements.

### DETAILED DESCRIPTION

Conventional internal combustion engines are generally configured such that the piston rings or other sealing components tasked with keeping engine oil from entering the combustion chamber are positioned above the lubricated components of the engine. For example, the crankcase of a conventional engine is typically located below, or at least no higher than, the pistons and combustion chambers such that the piston top dead center (TDC) position is at an equal or higher elevation within the engine architecture than the piston bottom dead center (BDC) position. As such, oil tends to drain with gravity away from (or at least not predominantly toward) the piston rings and into the combustion volume (e.g., where combustion occurs) of the combustion chamber.

A problem with inverted engine operation is that when the engine is shut down, oil tends to drain back into the cylinder and past the piston rings into the combustion chamber. Then on start up, this oil is burned, resulting in unacceptable oil consumption as well as elevated generation of smoke and pollutants.

Oil is generally not inhibited from traveling past the oil control rings or the compression rings in a stationary situation if oil is continuously supplied to those components. Capillary forces can draw the oil past the rings and into the combustion chamber. For an engine in which a piston is inverted as described above, this effect can be problematic because oil in the crankcase and on other surrounding engine components tends to drain with gravity. As noted above, this effect is generally not an issue with a conventionally oriented piston because gravity causes the oil to drain away from the rings. However, while in an inverted orientation, oil tends to drain toward the rings.

The oil can pass the piston rings because of gaps in the rings for fitment as well as because there is no pressure holding the ring against the side of the groove when it is stationary, particularly with respect to the compression rings. Clearance needed to allow for differential expansion between the piston and the ring can leave relatively large gaps compared to gaps needed for oil to be pulled through by capillary motion. The oil “wets” metal surfaces with a near zero contact angle. Even films that claim to be oil phobic have only shown approximately 40° contact angles, so they are not sufficient to stop oil migration in an inverted configuration.

In certain engine configurations, it can be necessary or advantageous to have at least one piston in an inverted configuration (e.g. positioned such that the top dead center (TDC) position is at a lower elevation in the engine architecture than the bottom dead center position (BDC)). For example, in an opposed piston engine architecture (e.g. an engine in which the crowns of two pistons approach and are driven away from one another in the same combustion chamber), a non-horizontal (e.g. including but not limited to vertical) arrangement of the pistons (e.g. with a first crankshaft driven by a first piston or set of pistons positioned above a second crankshaft driven by a second piston or set of pistons) can enable easier packaging, reductions in engine mass, and/or cost, etc. A non-horizontal or even a vertical arrangement can also allow increases in breathing capacity of an opposed piston engine relative to a horizontal configuration. For example, in a horizontal configuration, the perimeter of a sleeve valve may be restricted to address fuel puddling. Furthermore, for a turbo charged engine, the available space envelope to add the turbo charging components may be more practical for a non-horizontal or even a vertical arrangement than for a horizontal arrangement. The power take-off (PTO) shaft can also be eliminated reducing cost and reducing the crank connection loads. Anon-horizontal opposed piston engine requires that one set of pistons runs “inverted” compared to a conventional orientation.

Some implementations of the current subject matter include features relating to one or more of limiting the amount of oil available to leak past the rings, providing vent passages to allow the oil to be directed to less harmful location, providing a more effective seal for the oil when the piston is stationary, increasing the volume of oil that can be stored in the piston crown at shut down, and controlling the friction added for these oil control features. The details of one or more variations of the subject matter described herein are set forth in the accompanying drawings and the description below. Other features and advantages of the subject matter described herein will be apparent from the description and drawings, and from the claims.

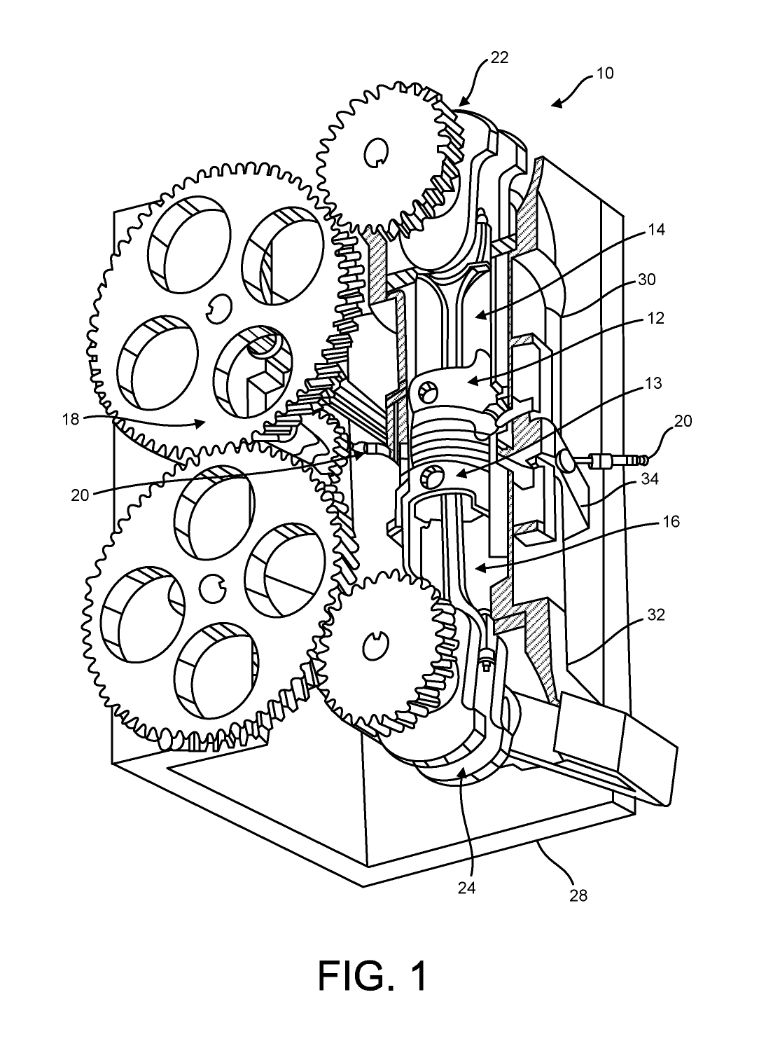

FIG. 1 of the accompanying drawings illustrates components of an internal combustion engine 10, according to an embodiment of the invention, including vertically opposed pistons (upper or top piston 12, bottom piston 13), top and bottom valve arrangements 14 and 16, components of a valve-control system 18, spark plugs 20, top and bottom power delivery arrangements 22 and 24, respectively.

In some implementations, the internal combustion engine 10 includes a base portion 28, top and bottom castings 30 and 32, and a central connecting piece 34. The top and bottom castings 30 and 32 are mounted to the central connecting piece 34. The assembly, including the top and bottom castings 30 and 32 and the central connecting piece 34, is secured to the base portion 28 to form a unitary piece with the base portion 28, the castings 30 and 32 and the central connecting piece 34 being immovably connected to one another.

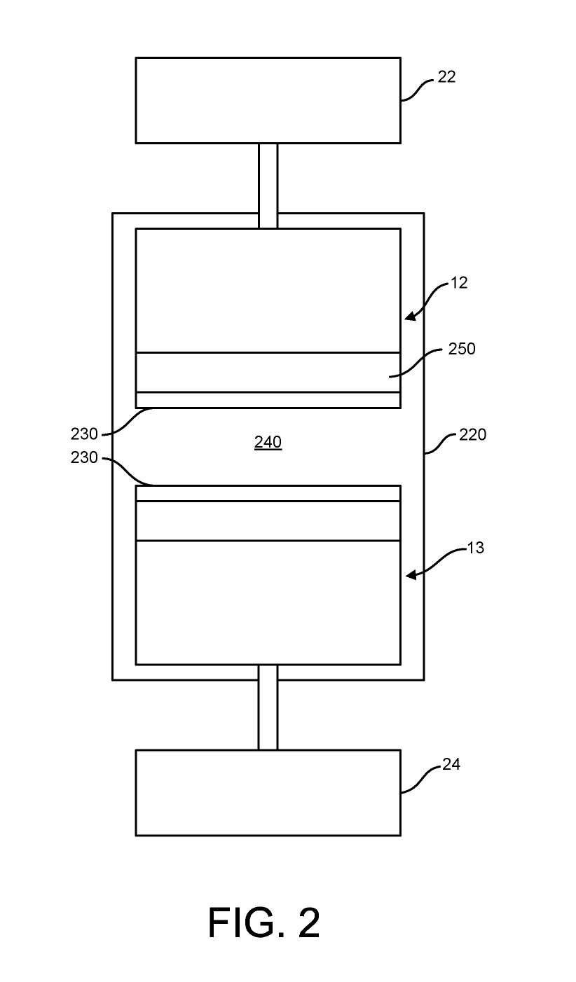

Reference is now made to FIGS. 1 and 2 in combination. In order not to obscure the drawings, not every detail in FIG. 1 is shown in FIG. 2, and not every detail in FIG. 2 is shown in FIG. 1. In general, FIG. 1 shows only general large assemblies, and FIG. 2 shows the components better that make up the larger assemblies, such as a vertically aligned opposed piston engine.

The top power delivery arrangement 22 includes the top piston 12 that can be coupled to a top crankshaft. The top piston 12 can reside within the top casting 30, and is slidably movable between BDC and TDC, of which TDC is positioned lower than BDC due to its inverted configuration (being vertically aligned). The top piston 12 can reciprocate within a cylinder 220 defining at least a part of the combustion chamber. A bottom surface or crown 230 of the piston is directed at a combustion volume 240 where combustion occurs within the combustion chamber. The combustion volume 240 can be defined between the crowns 230 of the top and bottom pistons 12 and 13, and by an inner surface of the cylinder 220 that at least partially encircles the top and bottom pistons 12 and 13. The top piston 12 can also include a cavity 250 positioned above the crown 230 and configured to contain fluid, such as oil, that leaks into the combustion chamber above the crown 230. Various mechanisms can be implemented in the internal combustion chamber for reciprocating either the top or bottom piston within the cylinder, such as cam-based mechanisms, all of which are within the scope of this disclosure. Furthermore, the bottom piston can also include any one or more features described herein regarding the top piston, such as a crown facing the combustion volume and/or a cavity positioned on an opposing side (e.g., below the crown).

An internal combustion engine 10 consistent with implementations of the current subject matter can include one or more features for controlling and/or limiting the amount of oil that is allowed to flow into the cavity 250 of the top piston 12, as well as limit or prevent oil from flowing into the combustion volume 240. In the first of several possible implementations of the current subject matter, an oil control (e.g. flow limiting) ring can be included in an internal combustion engine for assisting with controlling the direction of flow of oil into the cavity. In some examples, the oil control ring can be formed of a polymer and have a low tension. The lower limit on the tension in such an oil control ring can be set by an internal force required to regain its shape/contact with the inner diameter of the cylinder bore within which the associated piston reciprocates.

During movement of the top piston towards BDC, the inertia of the oil control ring and the tapered faces can generate a force to compress the ring so as to reduce/eliminate the ring to bore contact and therefore reduce/eliminate the friction contribution and reduce/eliminate concerns of changing retained wall oil film to maintain standard ring pack and skirt function. During movement of the piston towards TDC, the mirrored geometry of the oil control ring can produce the same effect as noted above. When the engine stops, regardless of piston direction/loads on the oil control ring, the geometry allows oil to gather and drain through to the ring groove and hence through to the piston cavity rather than down to the ring pack

In addition to a flow limiter positioned within the combustion chamber, the internal combustion chamber 10 can include one or more flow limiters positioned outside of the combustion chamber for limiting and/or controlling the amount of oil that is allowed to flow in the direction of the combustion chamber. For example, such flow limiters can include check valves positioned along a fluid pathway that is in fluid communication with the combustion chamber (e.g., cylinder) and/or crankcase, a check valve positioned adjacent a squirt nozzle configured to cool the top piston, and/or a splash shield positioned adjacent the piston.

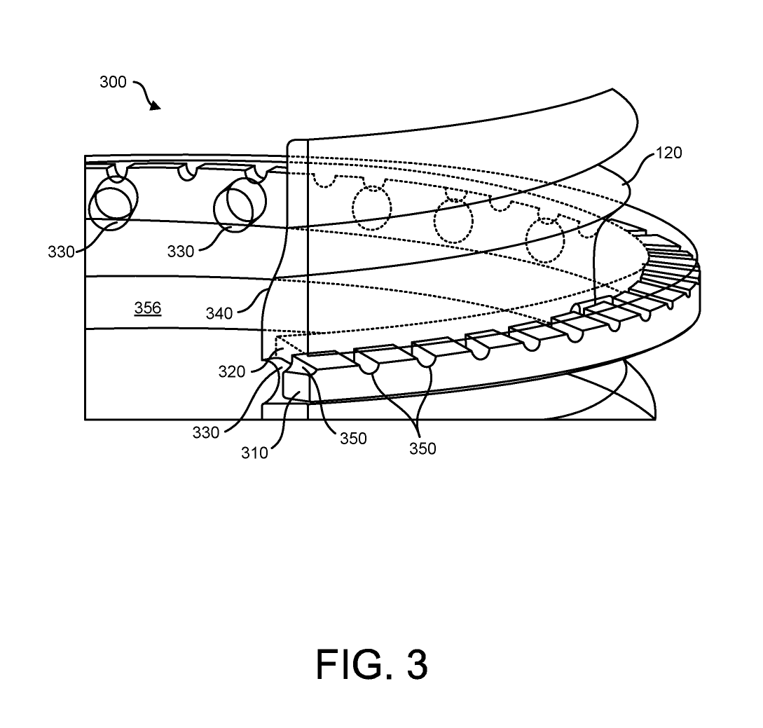

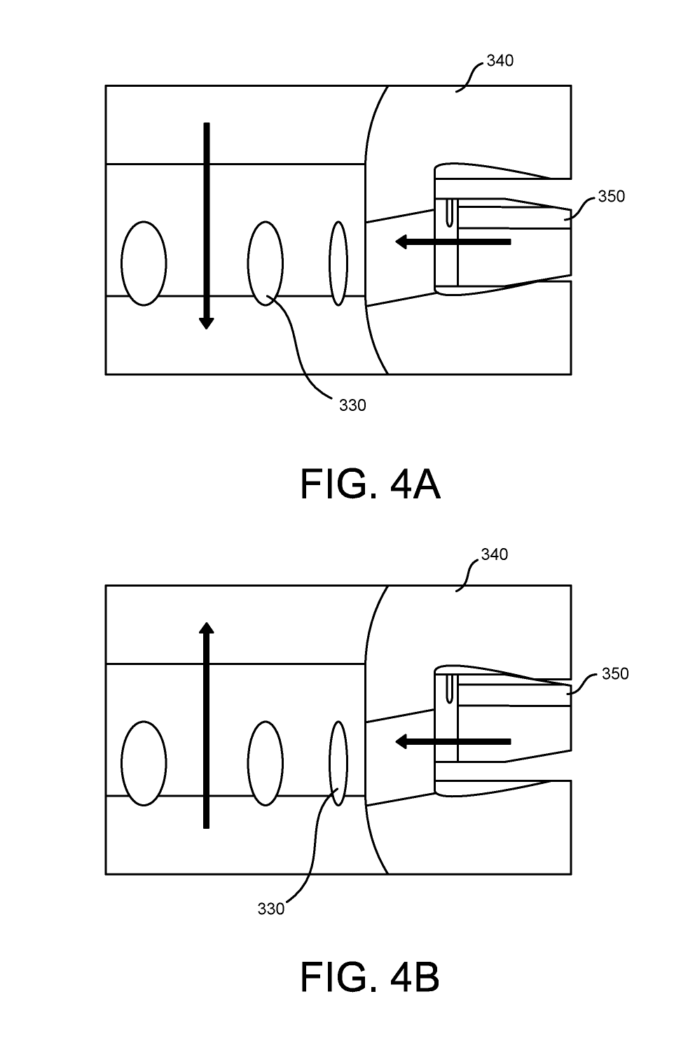

FIGS. 3-5 illustrates an embodiment of an oil control ring 310 coupled to a top piston 120 consistent with implementations of the current subject matter. As shown in FIG. 3, for example, the oil control ring 310 is positioned along a perimeter of the top piston 120, such as in a groove 320 of a piston body 340. The groove 320 includes angled faces on the top and bottom of the groove 320. The oil control ring 310 also includes matching angles on the top and bottom surfaces. A set of oil drainback drillings 330 are formed to drain oil from the groove 320 into the piston body 340, such as into a cavity 356 formed within the piston body 340 that can contain a volume of oil (e.g., approximately 5 cubic centimeters to approximately 15 cubic centimeters). The oil control ring 310 can also include a set of grooves 350 configured to match up to oil drainback drillings 330 that provide a fluid pathway to the cavity 356 within the piston body 340

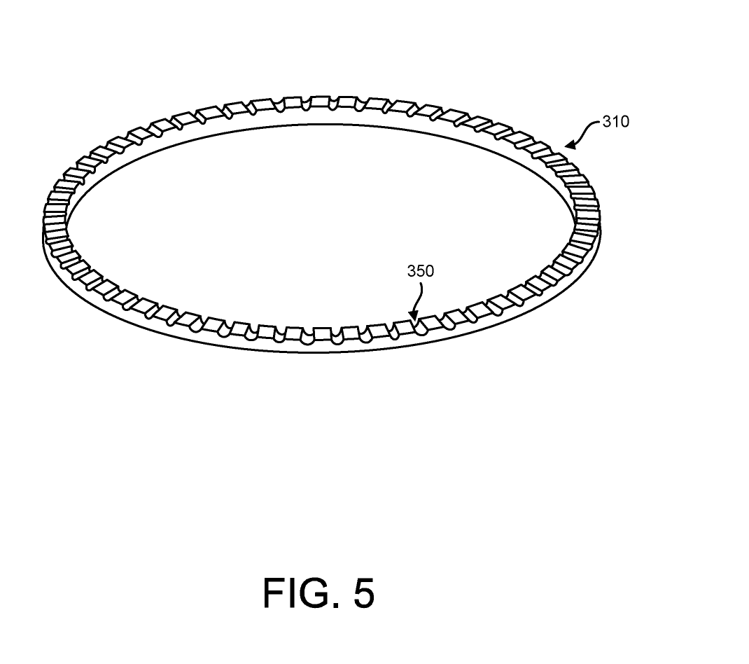

For example, during movement of the piston 120 towards BDC, the inertia of the oil control ring 310 and the tapered faces can act to generate a force to compress the oil control ring 310 so as to reduce or eliminate the ring-to-bore contact. This can reduce or eliminate the friction contribution and concerns of changing retained wall oil film to maintain standard ring pack and skirt function. During movement of the top piston 120 towards TDC, for example, mirrored geometry can produce the same effect as noted above. When the engine stops, regardless of piston 120 direction and/or loads on the oil control ring 310, the geometry allows oil to gather and drain through to the ring groove and hence through to the piston cavity as opposed to down towards to the ring. As shown in FIG. 5, the oil control ring 310 can include face angles. The face angles can be determined by operative speed required to deactivate. An internal diameter clearance and gap can set the maximum travel for ring compression. In some implementations, the oil control ring 310 is cast during manufacturing. One or more surface coatings can be applied to the oil control ring 310, such as for assisting with reducing friction (or “stick-tion”).

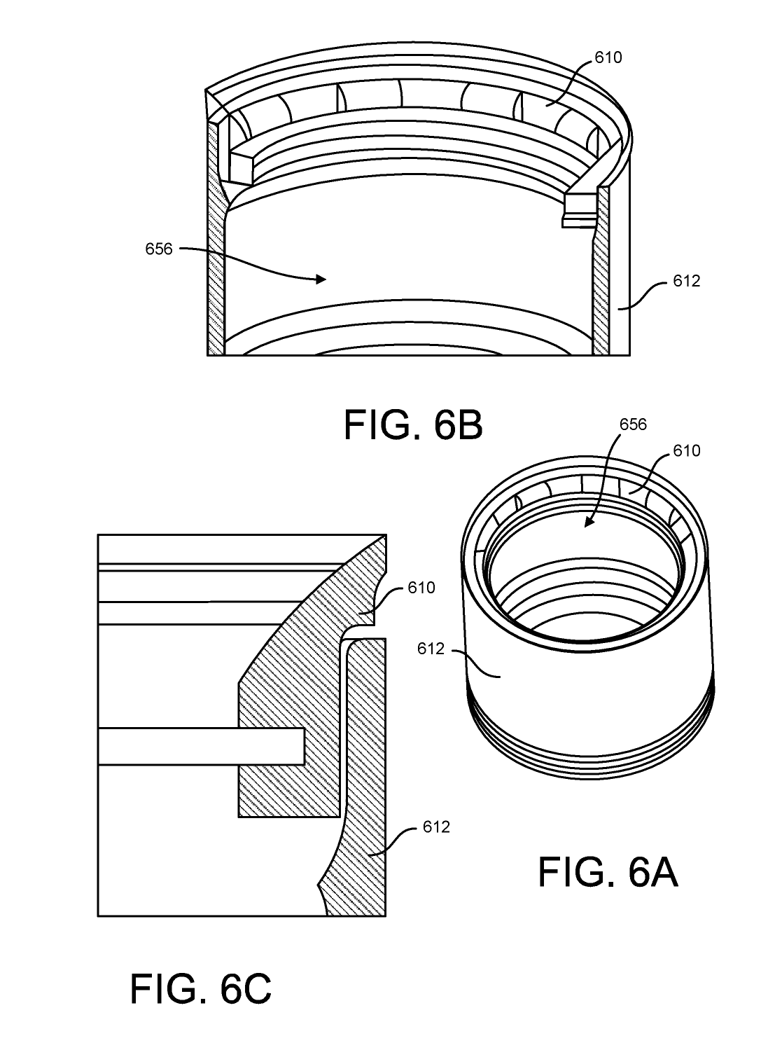

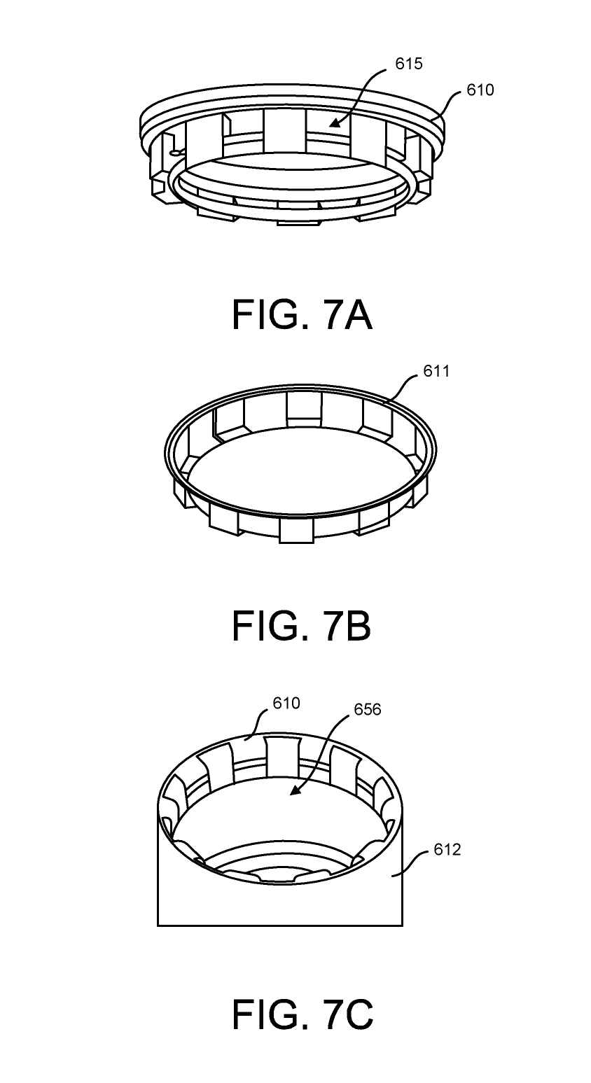

In another of the several possible implementations of the current subject matter, a molded seal 610 can be used, such as for example a molded seal 610 including one or more of the features shown in FIGS. 6A-6C and FIGS. 7A-7C. For example, the molded seal 610 can be formed of a material appropriate for the physical, chemical, and thermal conditions to which such a piston ring is typically exposed in an internal combustion engine. The seal 610 can include one or more cast spigots 615. The shape of the spigots 615 can vary and are not limited to a particular size or shape. The piston 612 can include reliefs having clearance that allow oil to drain between the lower lip of the seal 610 and the piston 612 thereby causing the oil to drain into the cavity 656 of the piston 612. The seal 610 can be retained, for example, by a wire and/or clip. The seal 610 can include a contact feature for low contact pressure and can be cut back to facilitate oil removal into the cavity 656 of the piston 612. As shown in FIG. 7B, a brace 611 can provide support to the seal 610, such as by overmolding the seal 610 onto the brace 611. The brace 611 can be made out of a variety of materials, such as steel, which can assist with supporting load, such as from piston acceleration. A groove can be cut into the piston 612 to restrain a wire and/or clip for securing the seal 610 in place. Additional features can be incorporated into the piston 612 (e.g., open ended chamfer) and/or seal to promote oil flow into the cavity 365 of the piston 612.

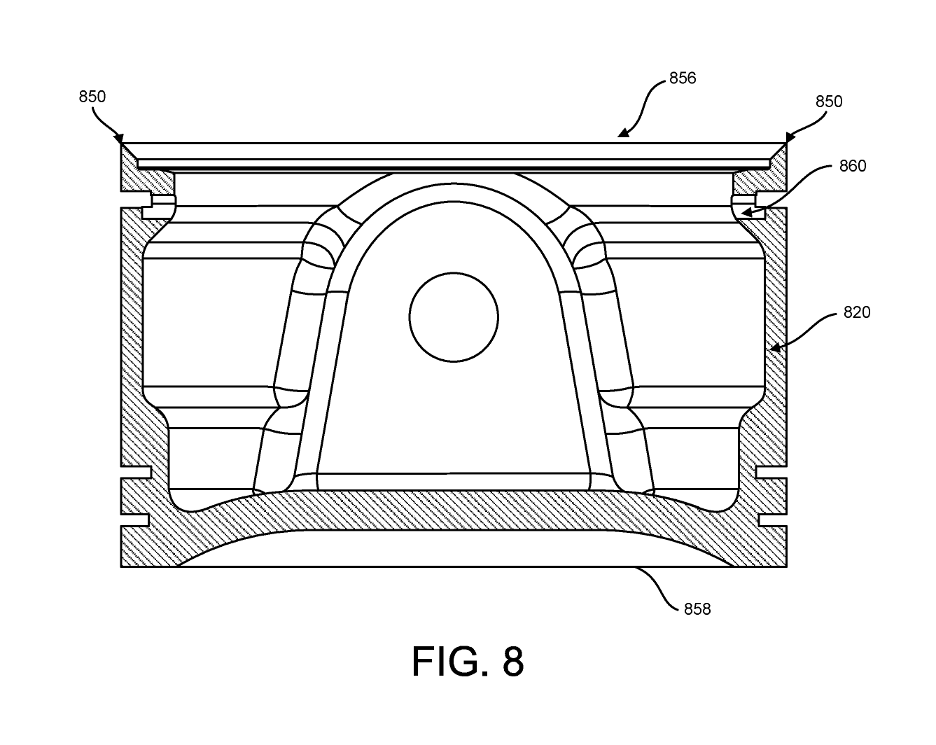

In yet another of the several possible implementations of the current subject matter, an example of which is shown is FIG. 8. This implementation can provide advantages in keeping the piston 820 as close to the bore (e.g., cylinder bore) as possible below the bottom ring and including a scraper feature 850 to direct oil runoff into the cavity 856 of the piston body (e.g., above the crown 858 of the piston). One or more dormered (e.g., covered) drainback features 860 can be included for controlling oil that gets past the scraper feature 850. In some examples, the drainbacks 860 can be slots as opposed to radial drillings to encourage quicker flow. The scraper can optionally include a discontinuity in the skirt register. Depending on available room, the scraper may be more pronounced. This feature may provide further benefits in reducing the load of the now lowered oil control ring. In some further examples, the scraper feature can be directed to push the oil toward the bottom of the crown/wrist pin for some more direct oil cooling.

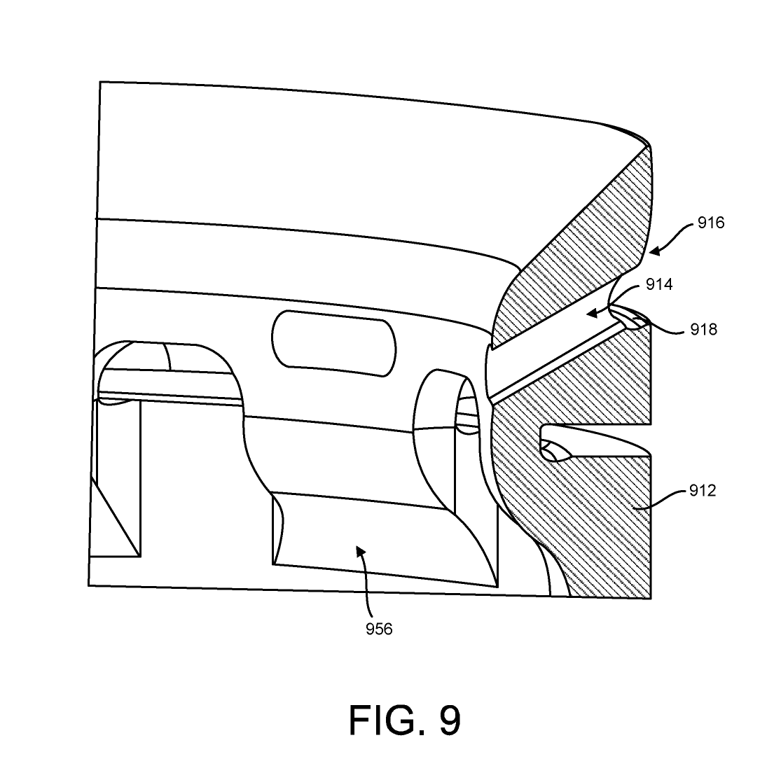

FIG. 9 shows a curvature included on a piston 912 surface leading into a first vent 914. The upper groove 916 is curved on the face towards the cavity 956 and the base of the lower groove that would carry the oil control ring also has a machined groove 918, this is done with the intention of drawing the oil into these lower regions to aid migration of the oil to the inside of the piston crown as opposed to down the outside. This may provide an advantage by pulling oil with surface tension into the piston cavity 956.

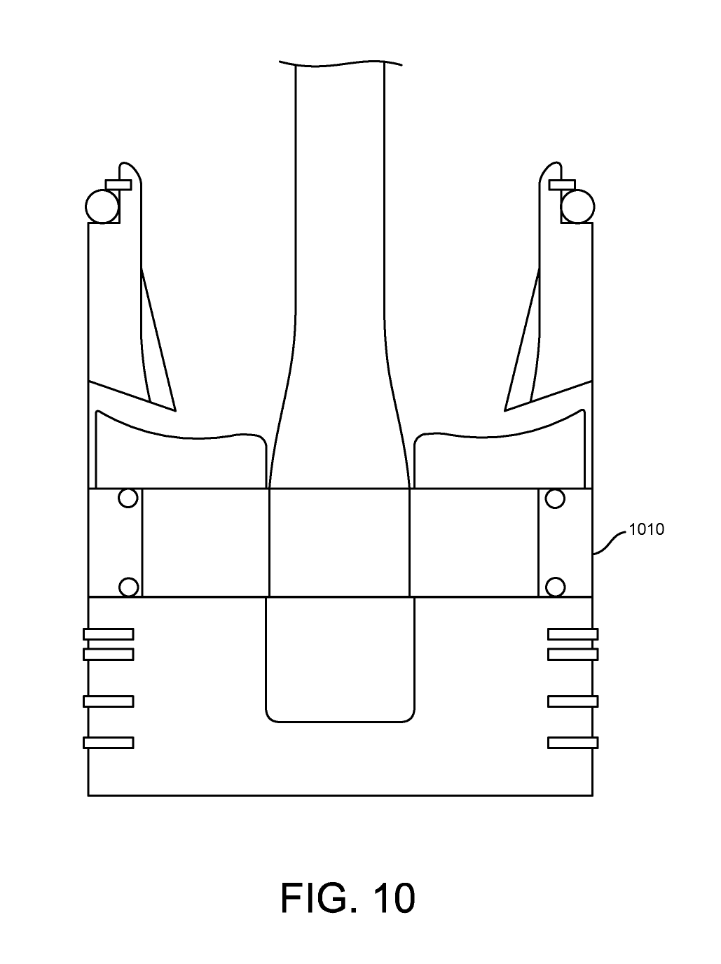

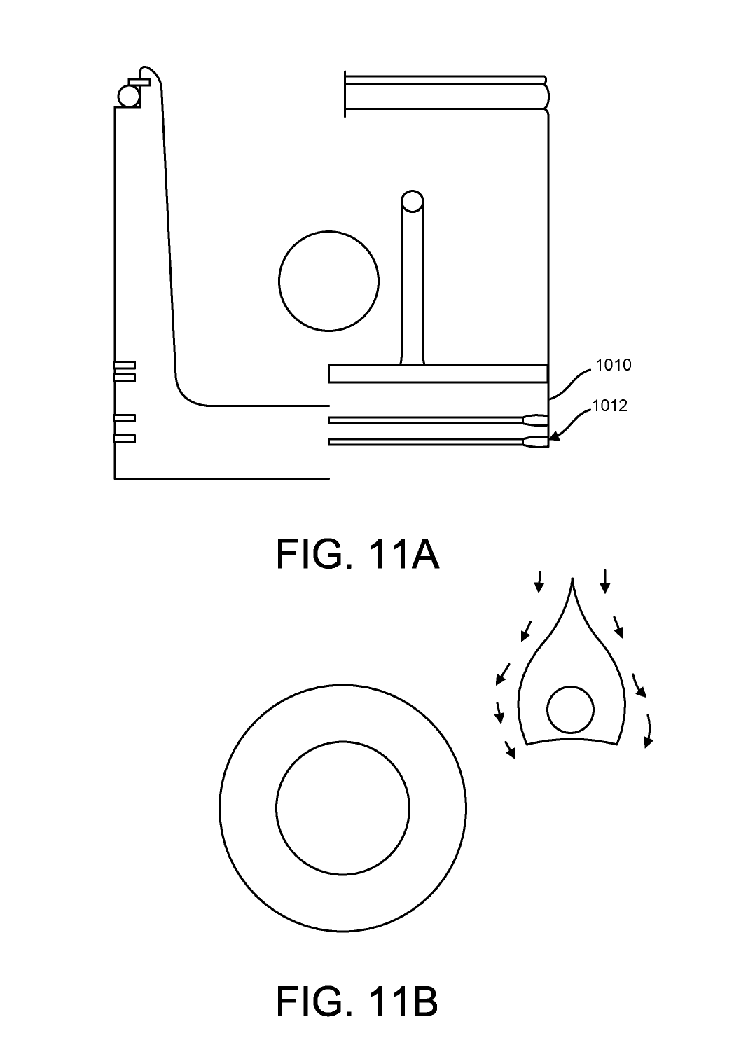

In still another of the several possible implementations of the current subject matter, a fully skirted or full round piston can be used. Such a feature can provide advantages in that the amount of oil collected in the piston cavity and the wall is minimized. Plugs can also be used that also seal the pin bores. The plugs take up the volume that might have been left for oil to accumulate. A piston pin end cap 1010, such as for example as is shown in FIG. 10 and FIGS. 11A-B, can be included for closing off a leak path from the interior of the piston 1012 to near the cylinder wall. This feature can also cause the end volume to be filled so that a minimum of oil ends up being stored there (less volume to drive capillary action). FIG. 11B shows a diagram of a view from inside the piston looking out at the vent coming from the oil control ring. It has a “dormer” to try to deflect the oil draining down from the cylinder wall and the piston skirt away from the vent that connects to the oil control ring.

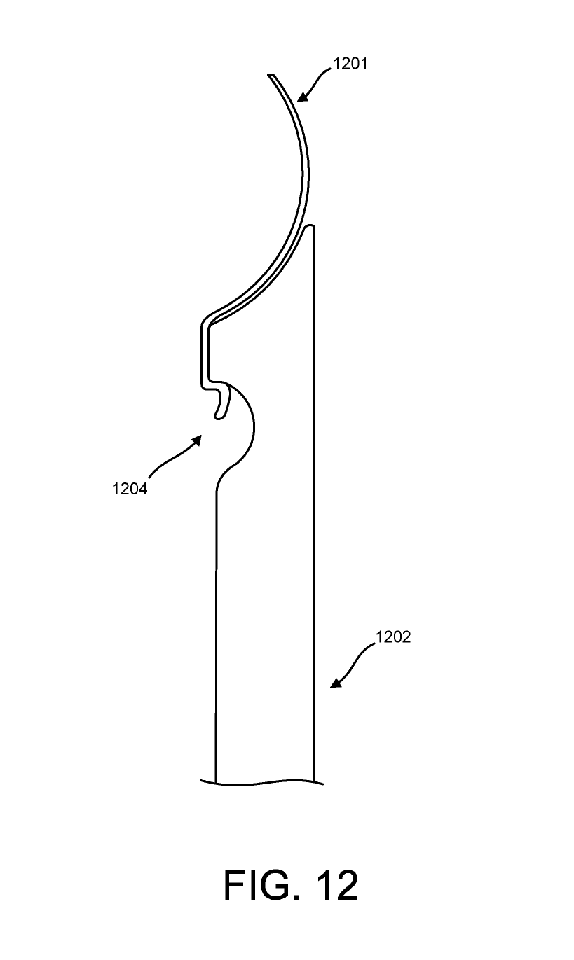

A “c” ring may be undesirable in some implementations of the current subject matter because too much oil can be held above it by the height of both the snap ring and the skirt material to make the snap ring groove. Features shown in FIG. 12 may address such concerns by use of a shape (e.g., curved) that has very little volume above the seal surface. Such an approach also has the opportunity to force a film of oil between the seal 1201 and the piston wall 1202 when at reciprocating speed, reducing friction and insuring adequate oil to lubricate the piston/cylinder wall interface. Some versions consistent with this implementation may also benefit from the vent holes described in relation to other implementations of the current subject matter. One or more securing features 1204 associated with the seal can engage and secure to complimenting features along the piston 12, as shown in FIG. 12.

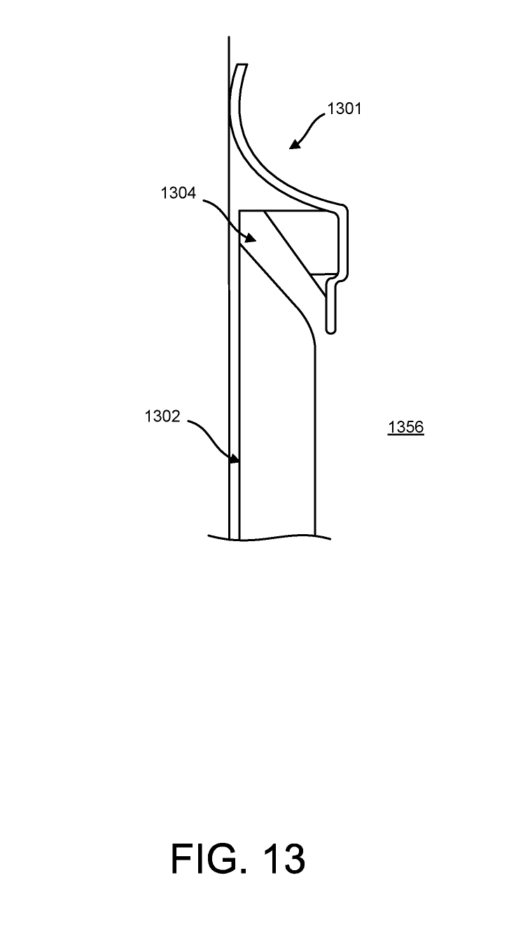

FIG. 13 also shows features consistent with this implementation. If the gap at the tip of the seal 1301 can be held to a few tenths of a millimeter, capillary forces can keep the oil in place, even if the honing grooves might allow it past. Honing grooves can optionally be replaced by laser honing. The laser leaves small discontinuous pits that might prevent a continuous path past the seal. Other approaches, such as for example other structured bore methods (e.g. MAHLE's Cromal) can also be used. As shown in FIG. 13, the piston wall 1302 can include one or more drainback slots or holes 1304 that allow oil that migrates by the seal or is trapped at engine shutdown to drain into the cavity 1356 of the piston.

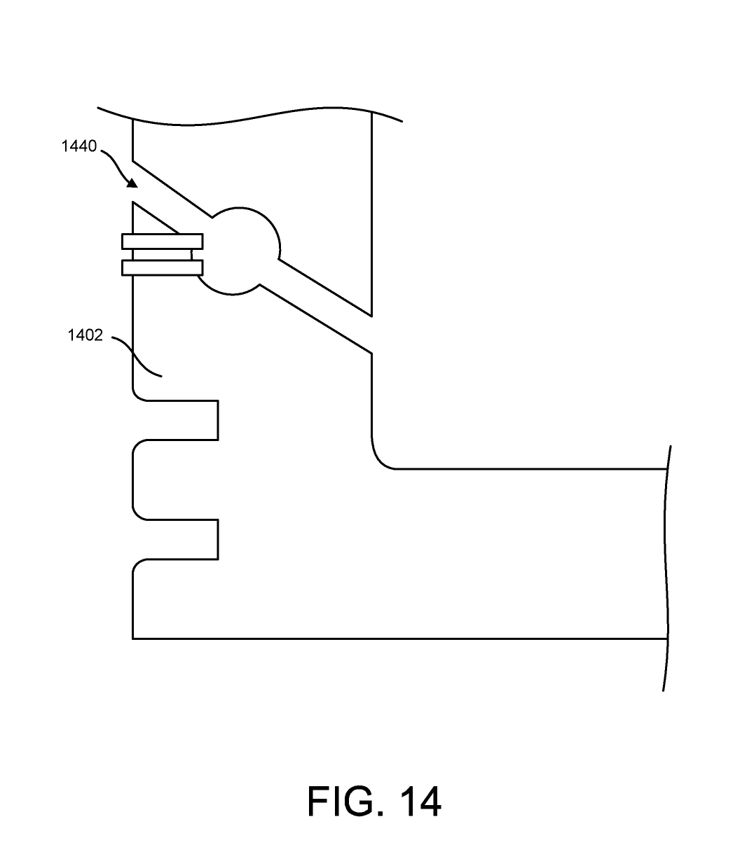

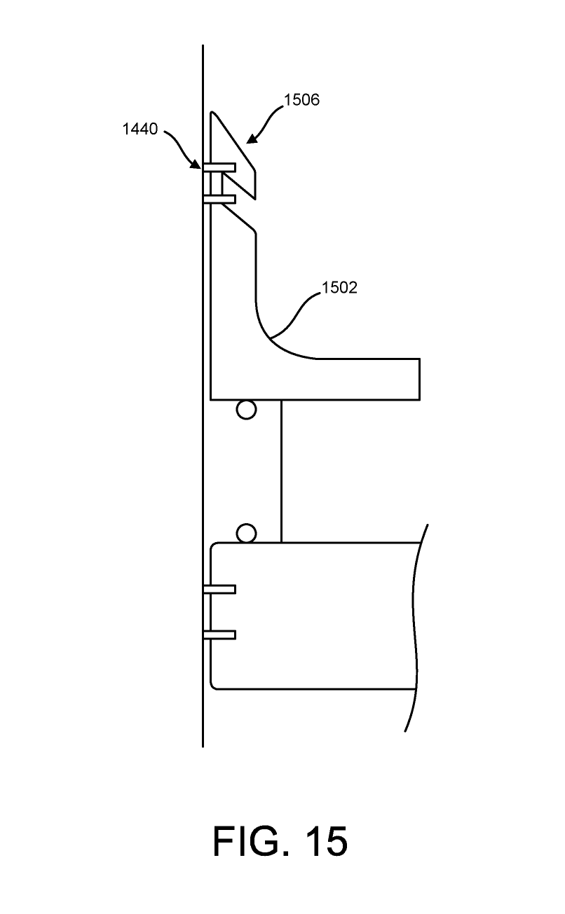

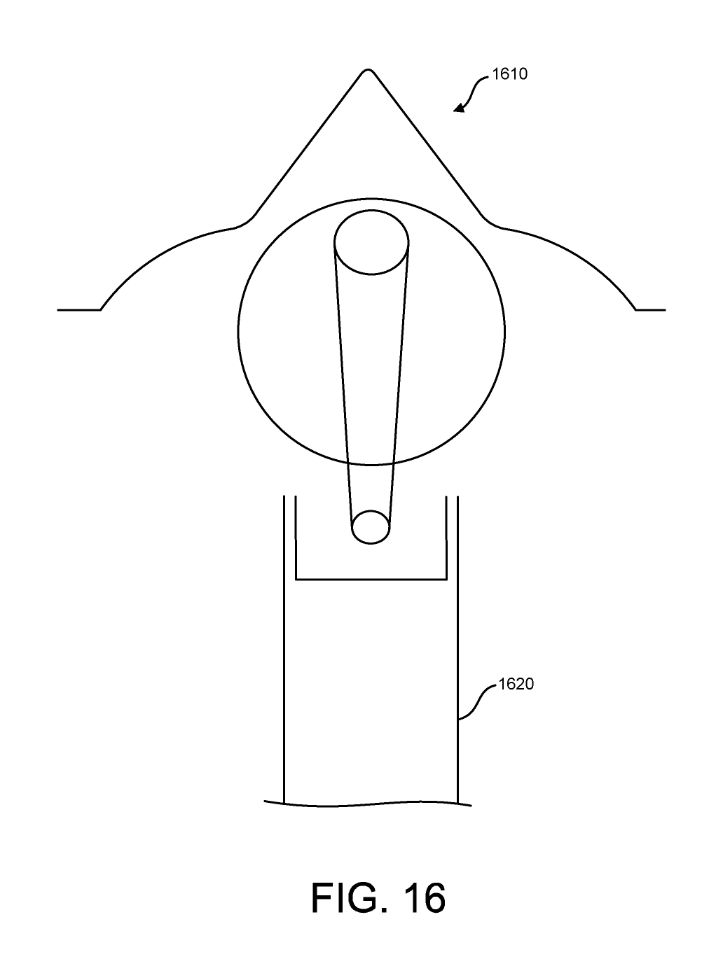

In other possible variations, which are shown in FIG. 14, FIG. 15, and FIG. 16, a recess cut 1440 can be formed behind the oil control ring coupled to the piston 1402 to collect and re-route oil drained away from the oil control ring by its shape or by other features. In FIG. 15, a tapered end 1506 of a skirt if a piston 1502 can minimize the size of the oil fillet that can remain above the oils control ring. In FIG. 16, an upper oil pan can include a “tent” 1610 above the cylinder 1620 and having steep sides such that oil splashed onto the pan is caused to drain down away from the cylinder before it drips off.

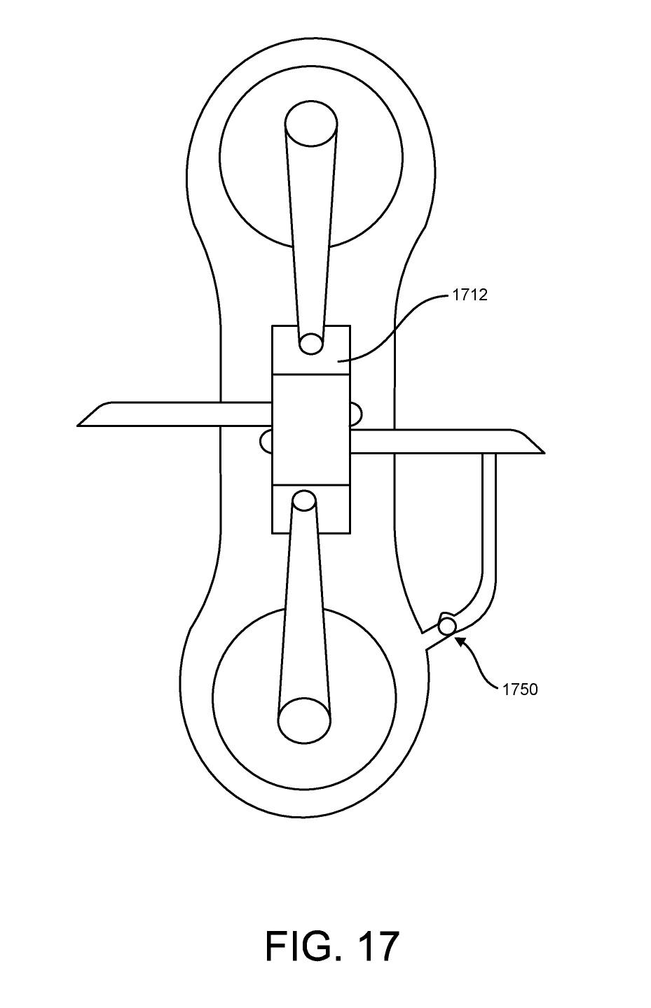

In yet another of the several possible implementations of the current subject matter, an example of which is illustrated in FIG. 17, a significant pressure differential can be created between the chamber at high pressure to the crankcase at low pressure. This pressure differential can tend to push the oil away from the rings so that it can be drained into the piston 1712 where it would then not be able to come back once the pressure equalized. A check valve 1750 can also assist with controlling oil flow direction.

In a related option, a de-compressor can be incorporated such that at shut down, the de-compressor would hold the exhaust valve open a bit so that the combustion chamber can be maintained at (or at least very close to) the ambient pressure. Doing so can assist in avoiding a substantial pressure difference between the crankcase and combustion chamber without the above crankcase venting set up. This feature can be used individually or in addition to other features discussed herein.

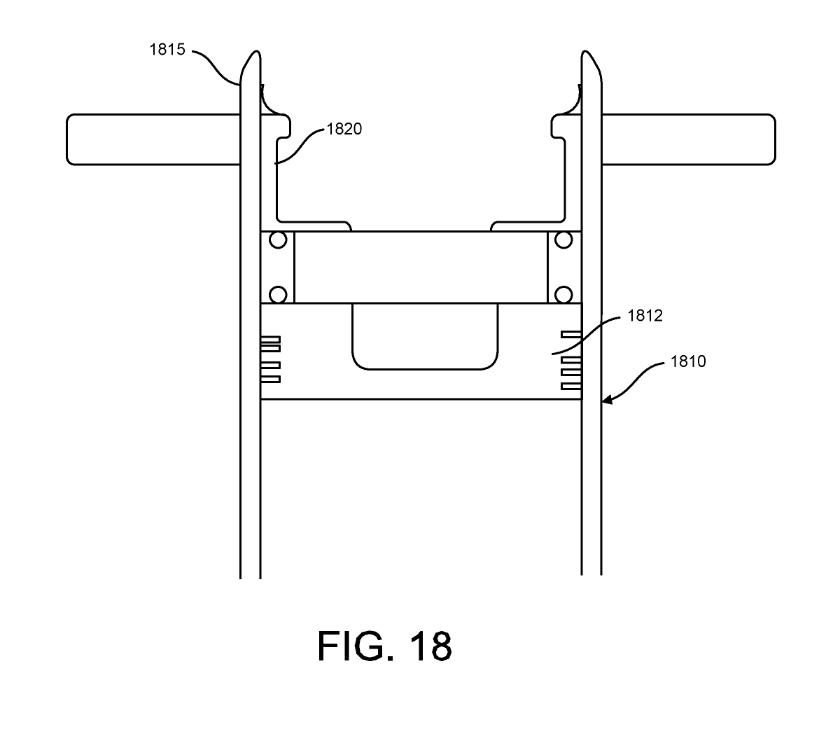

FIG. 18 shows features consistent with anther implementation. For example, a sleeve valve 1810 surrounding a top piston 1812 is raised compared to other features in order to prevent oil from draining into the sleeve valve 1810. A top end of the sleeve valve 1810 can include a taper 1815 that directs oil away from draining into the sleeve valve 1810. The seal 1820 can have a 360 degree contact with the sleeve valve 1810 or cylinder wall, and an inner wall of the seal 1820 can include a taper for allowing a ring to compress the seal during assembly.

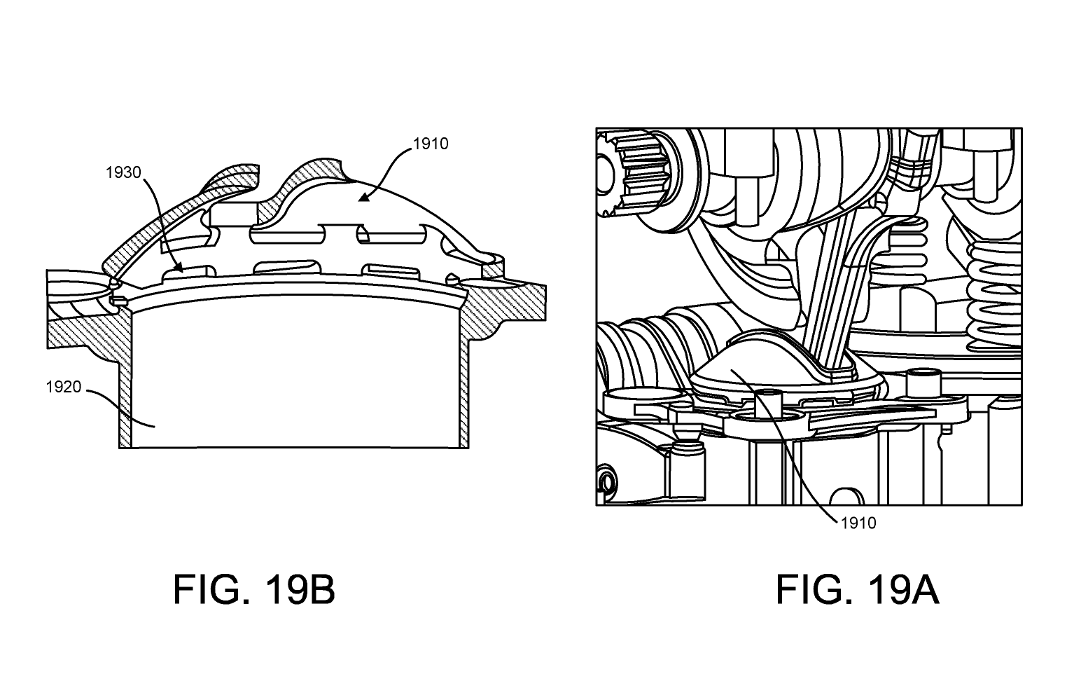

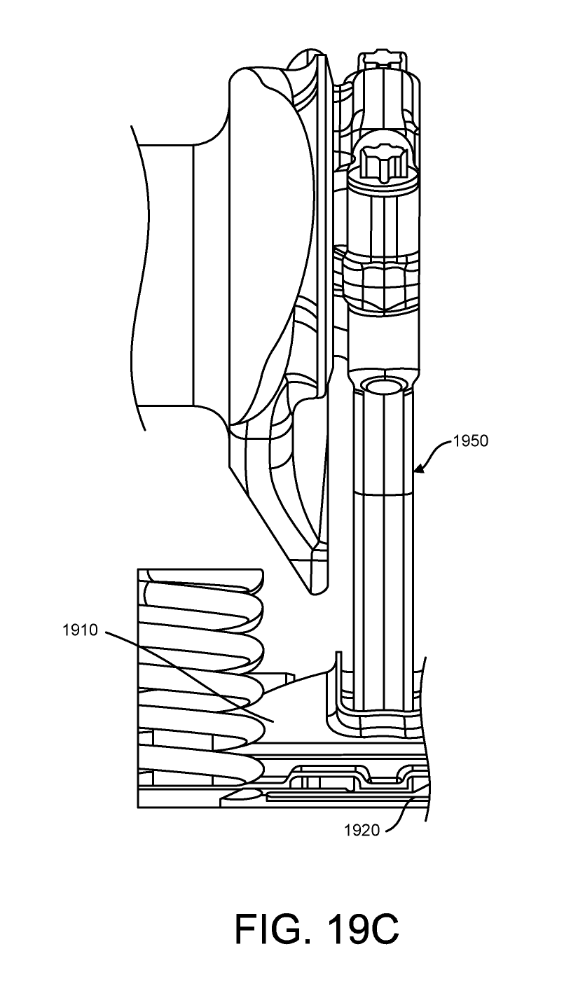

FIGS. 19A-19C show examples illustrating an additional implementation of the current subject matter, which can include a splash shield 1910 attached to a sleeve valve 1920 so that oil that would normally drip into the inverted bore would be deflected away. Such a shield 1910 need not provide complete coverage, but may cover a primary source of oil that could potentially pass the oil control rings (e.g., oil draining out of the main bearings). In some implementations, the splash shield 1910 is positioned adjacent a check valve that limits or controls the flow of oil in the direction of the splash shield 1910. The shield 1910 can include one or more vents 1930 such that the oil that is intentionally sprayed into the back of the piston can splash out with little resistance during operation. For example, a vented sleeve cap 1910 can be slotted for connecting rod articulation and can either clip to or otherwise be mechanically fastened to the sleeve assembly.

Internal drain features (e.g. the upper slots as shown in the orientation of FIG. 19B) can allow any oil splashed onto the cover underside to escape. Oil coating the internal surface can run down the face to the upper series of slots and drip outside the sleeve cavity. Some form of clocking or overlap to the lower vent slots can be included to prevent drain oil from being fed back internally.

FIG. 19C shows a crank feature 1950 in a thrust region that can assist in causing any oil that drains out of the pin to drop outside the slot as oil leakage would do. Oil can be assumed to follow the face on the crank attached. Such a feature can be used in conjunction with the sleeve cap 1910. The thrust face of the crankshaft can be of a larger diameter than that of the connecting rod/cap. At the connecting rod edge, the oil will tend to adhere to the crank surface. The crank face outside of the thrust region can have an angle that takes the oil outside of the sleeve cap opening. A drip forming feature can also be included along the outer edge of the crank face.

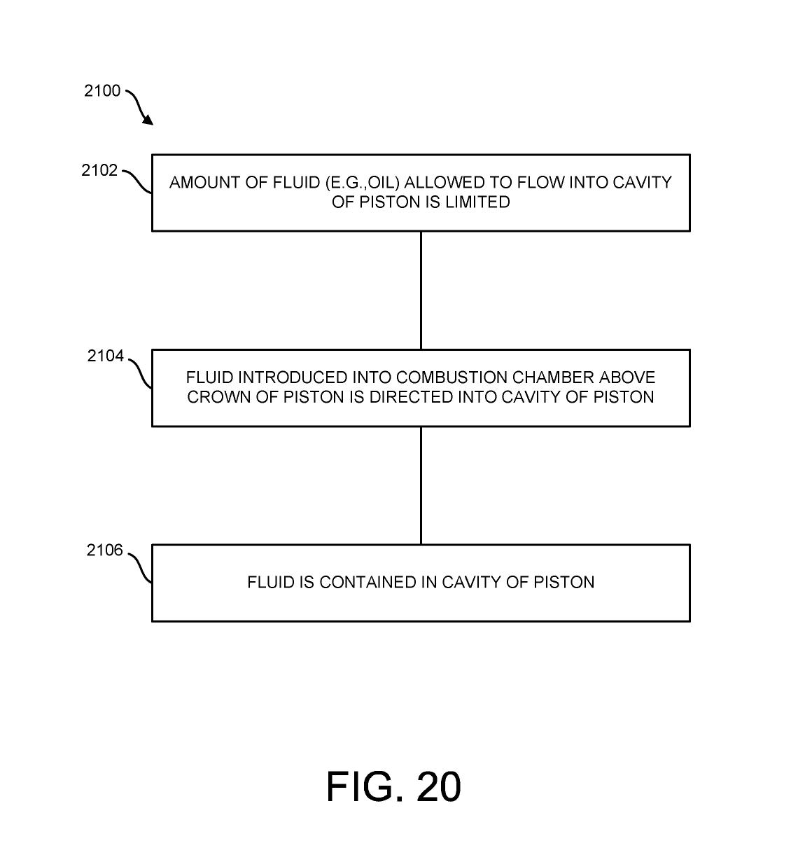

FIG. 20 shows a process flow chart 2100 illustrating features of a method consistent with one or more implementations of the current subject matter. It will be understood that other implementations may include or exclude certain features. At 2102, an amount of fluid (e.g., oil) allowed to flow into a cavity of a piston is limited. At 2104, the fluid introduced into the combustion chamber above the crown of the piston is directed into the cavity of the piston. At 2106, the fluid is contained in the cavity of piston.

Implementations of the current subject matter can include, but are not limited to, articles of manufacture (e.g. apparatuses, systems, etc.), methods of making or use, compositions of matter, or the like consistent with the descriptions provided herein.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” Use of the term “based on,” above and in the claims is intended to mean, “based at least in part on,” such that an unrecited feature or element is also permissible.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. Other implementations may be within the scope of the following claim.

What is claimed is:

1. An internal combustion engine, comprising:
a piston that reciprocates within a cylinder that at least partially encircles the piston, the piston comprising a crown directed toward a combustion volume that is at least partially bounded by a wall of the cylinder and the crown, the piston reciprocating within the cylinder such that a position of the crown is lower when the piston is at a top dead center (TDC) position than when the piston is at a bottom dead center (BDC) position, the piston comprising a cavity positioned opposite the crown of the piston, the cavity having a cavity volume configured to capture fluid introduced into the cylinder above the crown of the piston;
a flow limiter positioned outside of the combustion volume and configured to limit an amount of fluid introduced into the cylinder above the crown of the piston.

2. The internal combustion engine of claim 1, wherein the flow limiter includes a check valve positioned along a fluid pathway that is in fluid communication with at least one of the cylinder and a crankcase of the internal combustion engine.

3. The internal combustion engine of claim 2, wherein the check valve is positioned adjacent a squirt nozzle configured to cool the piston.

4. The internal combustion engine of claim 1, wherein the flow limiter comprises a splash shield positioned adjacent at least one of the cylinder and a sleeve valve of the internal combustion chamber.

5. The internal combustion engine of claim 1, further comprising a seal ring positioned along a perimeter of the piston that directs fluid introduced into the cylinder above the crown into the cavity.

6. The internal combustion engine of claim 5, wherein the seal ring is made out of a polymer.

7. The internal combustion engine of claim 5, wherein the seal ring comprises one or more grooves that align with one or more openings along the piston for providing a flow pathway into the cavity.

8. The internal combustion engine of claim 5, wherein the seal ring comprises a shape that allows fluid between the seal ring and the piston when the piston reciprocates thereby providing lubrication between the piston and cylinder.

9. The internal combustion engine of claim 1, wherein the piston includes one or more drainback apertures along a piston wall that allow fluid to flow from outside the piston wall into the cavity.

10. The internal combustion engine of claim 9, wherein the drainback apertures extend at an angle that encourages oil to flow from outside the piston wall into the cavity.

11. The internal combustion engine of claim 1, wherein the volume of the cavity comprises a range of 5 cubic centimeters to 15 cubic centimeters.

12. The internal combustion engine of claim 1, wherein the fluid is oil.

13. A method of controlling fluid in an internal combustion engine, comprising:
limiting an amount of fluid allowed to flow into a cavity of a piston that reciprocates within a cylinder that at least partially encircles the piston, the piston comprising a crown directed toward a combustion volume that is at least partially bounded by a wall of the cylinder and the crown, the piston reciprocating within the cylinder such that the crown is positioned lower when the piston is at a top dead center (TDC) position than when the piston is at a bottom dead center (BDC) position, the cavity of the piston being positioned opposite the crown of the piston and having a cavity volume configured to capture fluid introduced into the cylinder above the crown of the piston.

14. The method of claim 13, wherein the limiting comprises one or more flow limiters restricting the flow of fluid into the cylinder above the crown of the piston.

15. The method of claim 14, further comprising directing the fluid introduced into the cylinder above the crown of the piston into the cavity of the piston.

16. The method of claim 15, further comprising containing the fluid in the cavity of piston.

17. The method of claim 13, wherein the fluid is oil.

18. The method of claim 13, wherein the volume of fluid comprises a range of 5 cubic centimeters to 15 cubic centimeters.
